(19) United States
(12) Patent Application Publication
(10) Pub. No.: US 2012/0147032 A1
(43) Pub. Date: Jun. 14, 2012

(54) MANIPULATION INFORMATION INPUT APPARATUS

(75) Inventor: Takahiro ISHIKAWA, Nagoya-city (JP)

(73) Assignee: DENSO CORPORATION, Kariya-city (JP)

(21) Appl. No.: 13/313,152

(22) Filed: Dec. 7, 2011

(30) Foreign Application Priority Data
Dec. 9, 2010 (JP) 2010-274513

(51) Int. Cl. G09G 5/00

(52) U.S. Cl. 345/619

(57) ABSTRACT

Several images are displayed based on instructions. A map image is displayed first as a base image. A destination setup image is then displayed as a manipulation image. A telephone number input image is then displayed also as a manipulation image. Then, an input of a telephone number of a destination is made to the telephone number input image. When an event occurs in the middle of the input, a present map image is alternatively displayed while the previously displayed images from the map image as a closest displayed base image up to the telephone number input image as an interrupted displayed manipulation image are recorded as an image transition in an image recording portion. When the event disappears, the recorded image transition is displayed from the closest displayed base image up to the interrupted displayed manipulation image, enabling smooth resumption of the interrupted input.

### CROSS REFERENCE TO RELATED APPLICATION

The present application is based on and incorporates herein by reference Japanese Patent Application No. 2010-274513 filed on Dec. 9, 2010.

### FIELD OF THE INVENTION

The present invention relates to a manipulation information input apparatus that interrupts an input of manipulation information in a middle and then assists a resumption of the input.

### BACKGROUND OF THE INVENTION

[Patent document 1] JP-H09-159468 A

Generally, a machine or a data processing apparatus such as a computer is equipped with an interface device which executes exchanges of input or output information with a manipulator. Such an interface device is also called an HMI (Human Machine Interface) device. The HMI device used in a vehicle has a characteristic usage that an input of the manipulation information is apt to be interrupted temporarily, as compared with an HMI device used at home.

A sudden event may occur during the input of the manipulation information into the HMI device (referred to as “input manipulation into the HMI device”) while driving a vehicle. For instance, such a sudden event includes a subject vehicle approaching a right-turn spot, and an ahead-traveling vehicle, which is ahead of the subject vehicle, slowing down. At an occurrence of such a sudden event, a driver who manipulates the HMI device needs to interrupt the input manipulation and concentrate on the driving. Then, when the measure to the event is completed and a leeway is given in the driving of the vehicle, the driver returns to the once interrupted input manipulation to the HMI device.

In such a case, the following is executed. When the vehicle runs, or when any manipulation by an occupant is not made for a predetermined time period, a manipulation image of the HMI device is retreated automatically. Further, a peripheral map of the present position of the vehicle is displayed on a screen. When the vehicle stops, or when an instruction is inputted which resumes an input manipulation into the HMI device (for example, when a button is pushed), the retreated manipulation image of the HMI device is automatically redisplayed (see Patent document 1).

However, when the HMI device is manipulated again after the interruption, the following may occur. That is, when the interrupted input manipulation to the HMI device is resumed, the occupant or driver may forget the procedure or steps of the input manipulation up to the interruption. It is thus necessary to repeat an input manipulation to the HMI device from the beginning. Therefore, the manipulation of the HMI device becomes troublesome.

Avoiding such a troublesome input manipulation may be done as follows. Even if the above-mentioned sudden event occurs, the driver gives priority to the manipulation of the HMI device, thereby completing the manipulation. The driver then concentrates on driving of the vehicle. However, this may cause a delay in the response to the occurrence of the sudden event.

Alternatively, even if the driver interrupts the manipulation to the HMI device and operates the vehicle so as to respond to the above-mentioned sudden event, another case may occur. That is, in order to return to the input manipulation to the HMI device smoothly, or, in order to try not to forget the procedure manipulated to the HMI device up to the interruption, the driver may not concentrate on the driving of the vehicle; in other words, the consciousness may depart from the driving.

### SUMMARY OF THE INVENTION

It is an object of the present invention to provide a manipulation information input apparatus which assists a smooth resumption of an input of manipulation information that was once interrupted.

To achieve the above object, according to an example of the present invention, a manipulation information input apparatus to display manipulation information in a display portion is provided as follows. An image generation portion is included to cause the display portion to display manipulation images and base images, the manipulation image being directed at a manipulated instrument, the base image being an image other than the manipulation images. An input portion is included to receive an interruption instruction and a return instruction, the interruption instruction executing an interruption image switchover to switch a displayed image from an interrupted displayed manipulation image to a present base image, the return instruction executing a return image switchover to return to the interrupted displayed manipulation image after having switched to the present base image. An image recording portion is included to record information on image transition from a closest displayed base image up to the interrupted displayed manipulation image, while the interrupted displayed manipulation image is being displayed in the display portion. A controller is included. Herein, when the interruption instruction is inputted via the input portion, the controller is configured to output (i) a recording control signal to the image recording portion so as to record the information on image transition information, and (ii) a base image display control signal to the image generation portion so as to display the present base image in the display portion. Further, when the return instruction is inputted via the input portion, the controller is configured to output an image transition display control signal to the image generation portion so as to display in the display portion the image transition from the closest displayed base image up to the interrupted displayed manipulation image, based on the information on image transition that is recorded in the image recording portion.

Such a configuration enables the following. The manipulator inputs manipulation information to a manipulated instrument and the manipulation image is displayed in the display portion. During the input manipulation, an event needing an interruption of the input or input manipulation occurs; thereby, the manipulator inputs information or an interrupt instruction to switch from the manipulation image to a present base image via the input portion. Then, the controller outputs a control signal which writes in the image recording portion the information concerning the image transition from a closest displayed base image up to a last displayed manipulation image that is displayed at the time when the interruption instruction is inputted. At the same time, the controller outputs a control signal which displays the present base image in the display portion. As a result, the present base image is displayed in the display portion. Herein, the last displayed manipulation image may be referred to as an interrupted displayed manipulation image to which the input manipulation is interrupted because of the input of the interruption instruction. Further, the present base image is, for instance, a map image that is inputted from a navigation portion at the present time. Thus, the present base image may be referred to an updated or live base image that is different from the closed displayed base image that is included in the image transition.

Then, a situation or event to enable the returning to the input manipulation comes to take place. Thereby, the manipulator inputs the information or the return instruction to switch the present base image to the interrupted displayed manipulation image. Thereby, the controller outputs a control signal which displays the image transition from the closest displayed base image up to the interrupted displayed manipulation image based on the displayed image transition information recorded in the image recording portion. As a result, the images included in the image transition are displayed and the interrupted displayed manipulation image is eventually displayed. The manipulator can thus remember the contents of the input manipulation before the interruption of the input manipulation, enabling smooth continuation or resumption of the input of the manipulation information.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a configuration of a manipulation information input apparatus according to a first embodiment of the present invention;

FIG. 2 is a diagram to explain an operation in a vehicular navigation apparatus;

FIG. 3 is a flowchart diagram for explaining a control process which interrupts an input manipulation in the manipulation information input apparatus of FIG. 1;

FIG. 4 is a flowchart diagram for explaining a control process which returns to an input manipulation in the manipulation information input apparatus of FIG. 1;

FIG. 5 is a flowchart diagram for explaining a control process for an input manipulation assistance in the manipulation information input apparatus of FIG. 1;

FIG. 6 is a block diagram illustrating a configuration of a manipulation information input apparatus and a vehicular navigation apparatus according to a second embodiment of the present invention;

FIG. 7 is a flowchart diagram for explaining a control process which interrupts an input manipulation in the manipulation information input apparatus of FIG. 6;

FIG. 8 is a flowchart diagram for explaining a control process which returns to an input manipulation in the manipulation information input apparatus of FIG. 6;

FIG. 9 is a diagram explaining a classification of a necessity degree in an input manipulation interruption according to a third embodiment;

FIGS. 10A to 10D are diagrams explaining an image transition when a manipulator executes an image switchover from a map image of a base image up to an image where a destination input using a telephone number is executed up to a middle of the input manipulation;

FIGS. 11A to 11D are diagrams explaining a display flow of an image transition by a recording assistance according to a fourth embodiment of the present invention;

FIGS. 12A to 12E are diagrams explaining an image transition from a map image of a base image to an image where a manipulator sets up a sound of an audio;

FIGS. 13A to 13E are diagrams explaining a displaying flow of an image transition by a recording assistance according to a fourth embodiment of the present invention;

FIGS. 14A to 14C are diagrams explaining a displaying flow of an image transition by a recording assistance according to a fifth embodiment of the present invention;

FIGS. 15A to 15C are diagrams explaining a displaying flow of an image transition by a recording assistance according to the fifth embodiment of the present invention;

FIGS. 16A to 16D are diagrams explaining a displaying flow of an image transition from a map image of a base image up to an image where a destination input using 50 Japanese syllabary characters is completed;

FIGS. 17A to 17C are diagrams explaining a displaying flow of an image transition by a recording assistance according to the fifth embodiment of the present invention;

FIG. 18 is a block diagram illustrating a configuration of a manipulation information input apparatus and a vehicular navigation apparatus according to a sixth embodiment of the present invention.

### DETAILED DESCRIPTION OF THE PREFERRED EMBODIMENTS

### First Embodiment

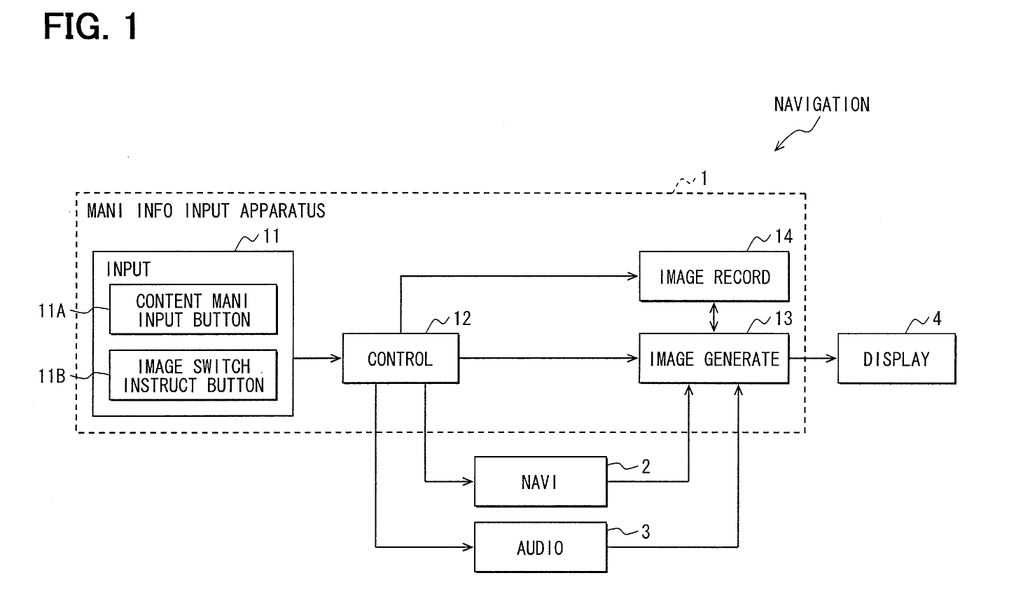

The following explains a first embodiment of the present invention with reference to FIGS. 1 to 3. FIG. 1 is a block diagram illustrating a configuration of a manipulation information input apparatus according to a first embodiment of the present invention.

A manipulation information input apparatus 1 according to the present embodiment is applied to an HMI (Human Machine Interface) device used in a vehicular navigation apparatus that is mounted in a subject vehicle. As indicated in FIG. 1, the vehicular navigation apparatus includes a manipulation information input apparatus 1 and other manipulated instruments that include a navigation portion 2, an audio portion 3, and a display portion 4.

The manipulation information input apparatus 1 is an interface device used for an input of (i) manipulation information to the vehicular navigation apparatus, and (ii) an image switchover instruction (i.e., image switchover information) to switch images displayed on a screen of the display portion 4.

The manipulation information input apparatus 1 includes an input portion 11 to which a manipulator inputs manipulation information, a controller 12 which outputs a control signal based on the inputted manipulation information, an image generation portion 13 which generates an image signal (information on image) of an image displayed on the display portion 4, and an image recording portion 14 in which an image signal is written.

The input portion 11 is an interface device into which the manipulator inputs various kinds of manipulation information. The input portion 11 includes a content input manipulation button 11A and an image switchover instruction button 11B. The content input manipulation button 11A is used for an input of manipulation information to the navigation portion 2 or the audio portion 3. The image switchover instruction button 11B is used for an input of manipulation information (instruction) which changes an image displayed in the display portion 4.

The content input manipulation button 11A includes a destination setup button, number buttons (i.e., numeral buttons), 50 Japanese syllabary character buttons, a position button for sound set-up, and a sound quality button for sound set-up. The image switchover instruction button 11B includes an interruption button used for interrupting an input manipulation of inputting manipulation information to the navigation portion 2 or the audio portion 3, a return button used for returning to the input manipulation that was interrupted, and an assistance button used for commanding a start of a recording assistance. The above interruption button, the return button, and the assistance button may be provided as being integrated into a single image switchover instruction button 11B, as separate several independent buttons responding to respective instructions, or as a crisscross formed button. Under the present embodiment, the image switchover instruction button 11B is provided as a single button as an example.

Further, the content input manipulation button 11A or the image switchover instruction button 11B may be a button (a button shaped switch device) as explained above. Alternatively, it may be a touch panel switch that is displayed in the display portion 4, a switch arranged in a steering wheel of the vehicle, a device or means for inputting manipulation information using speech recognition, or a device or means for inputting manipulation information using a gesture such as a manipulator's action.

The controller 12 is an arithmetic processing unit which reads various kinds of programs written in a built-in storage device, and execute data processing of various kinds of information. the controller 12 outputs the following control signals based on the manipulation information inputted by the manipulator: a control signal which controls generation of an image signal in the image generation portion 13; a control signal which controls writing of the image signal to the image recording portion 14; and a control signal which controls reading of the image signal from the image recording portion 14. Furthermore, the controller 12 converts the manipulation information inputted from the manipulator to the navigation portion 2 or the audio portion 3 into the control signals having the respective corresponding formats. The details of the control by the controller 12 are mentioned later.

The image generation portion 13 generates the image signal of the image displayed on the screen of the display portion 4. The image signals which the image generation portion 13 generates include (i) an image signal which displays manipulation images used for the input of the manipulation information to the navigation portion 2 or the audio portion 3, and (ii) an image signal which displays base images which are other than the above images.

The base images include a mere black image in which any information is not contained, an image which indicates guide data using a map by the navigation portion 2, an image displayed when music is performed by the audio portion 3, an image which indicates a temperature and a humidity in a vehicle compartment of the vehicle, an image (eco-meter) which indicates a fuel efficiency in the mid-travel of the vehicle, and an image which indicates an operation state of the engine or the motor in the hybrid vehicle, for instance. The manipulator can select as needed an image that is displayed as a base image from among the above exemplified base images.

The image recording portion 14 is a portion in which an image signal displayed on the display portion 4 is written. In other words, the image recording portion records or stores an image signal displayed in the display portion 4. The image signal written in the image recording portion 14 is read in order to display in the display portion 4. In the present embodiment, the image recording portion 14 uses a RAM (Random Access Memory) as an information storage media, for instance. Without need to be limited thereto, a hard disk or another storage media may be used.

The navigation portion 2 calculates a position, a direction, or a travel route of the vehicle based on data detected by various sensors such as a direction sensor and a distance sensor. Furthermore, a present position of the vehicle is amended based on the data acquired by the GPS (Global Positioning System) receiver. In addition, the navigation portion 2 reads map data corresponding to the amended present position of the vehicle from a storage media, displays as an image the read map data in the display portion 4, and outputs an image signal, which is processed so that the present position of the vehicle be displayed on the map image, to the image generation portion 13.

The audio portion 3 executes a channel selection of AM radio broadcast or FM radio broadcast based on the manipulation information inputted by the manipulator, and outputs a program content of the tuned-in broadcasting station as a sound. Furthermore, the audio portion 3 reads the music stored in a storage media such as CD (Compact Disc), and also outputs it as a sound. In addition, when outputting as sounds the program content of the broadcasting station or music, the audio portion 3 outputs an image signal of an image displayed on the screen of the display portion 4 to the image generation portion 13.

The display portion 4 displays an image on the screen based on an image signal generated by the image generation portion 13. In the present embodiment, the display portion 4 uses a liquid crystal display for instance. There is no need to be limited thereto. It can use an organic electroluminescence display or another image display device.

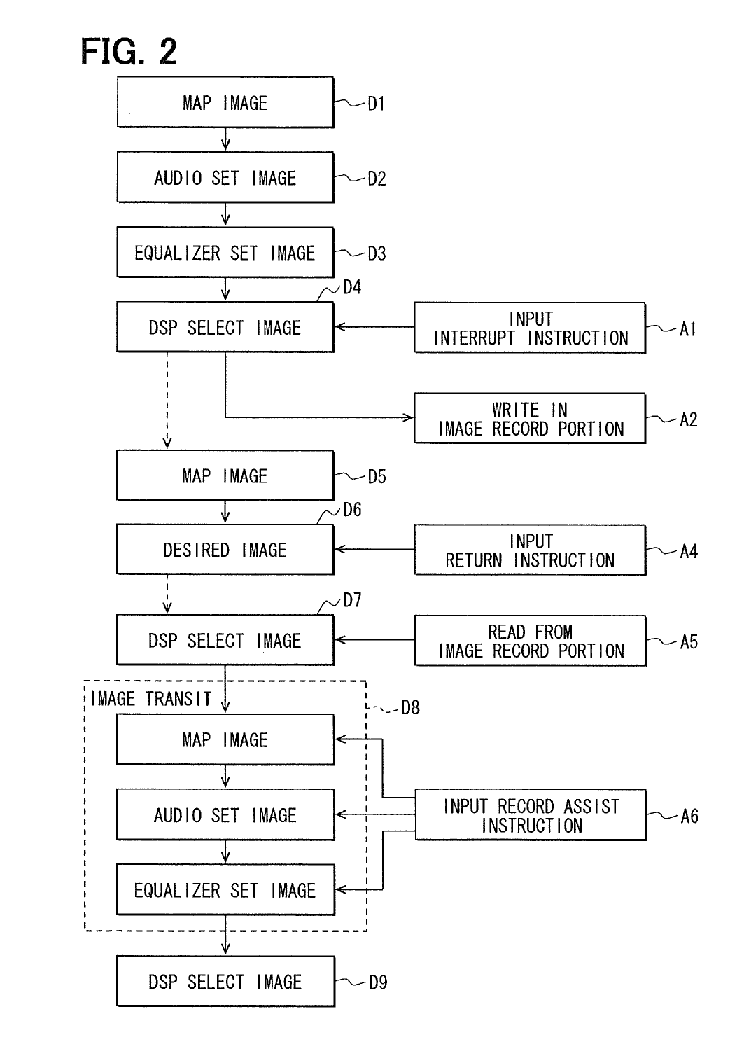

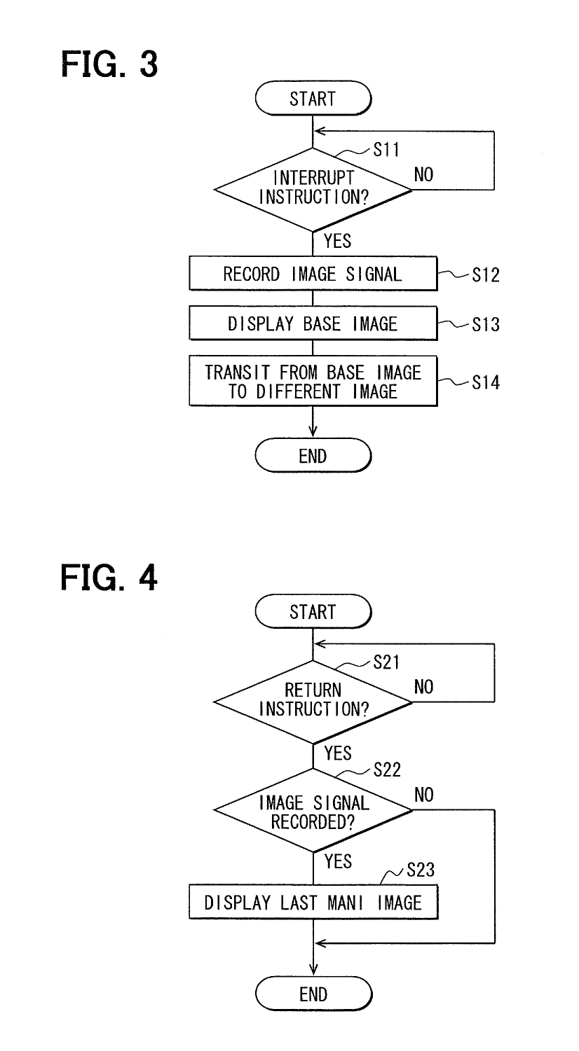

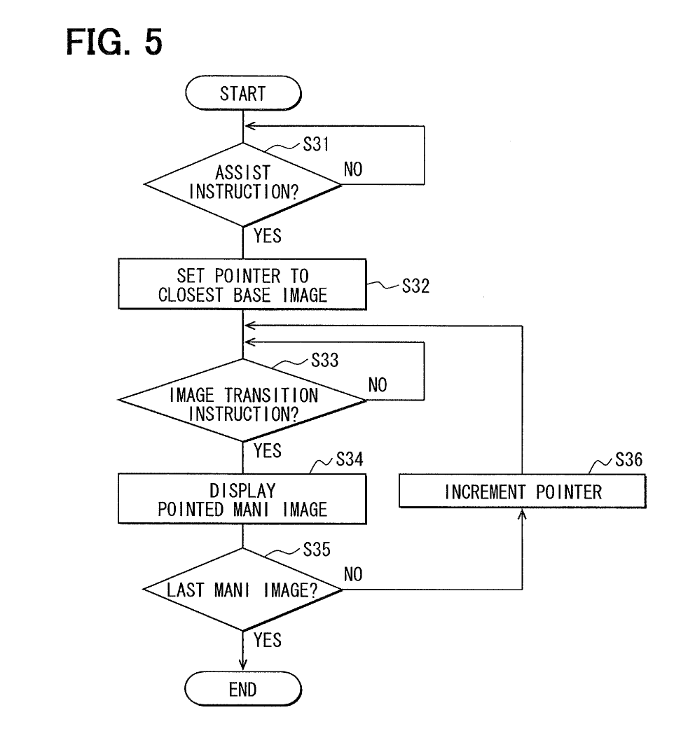

The following will explain an operation in the vehicular navigation apparatus or the manipulation information input apparatus 1. FIG. 2 is a diagram to explain an operation sequence or flow in the vehicular navigation apparatus. The left half in FIG. 2 explains the changes or switching of the images displayed on the screen of the display portion 4; the right half explains the operation or processing. FIG. 3 is a flowchart diagram for explaining an interrupt control process which interrupts an input manipulation in the manipulation information input apparatus of FIG. 1. FIG. 4 is a flowchart for explaining a return control which returns to the input manipulation that was interrupted. FIG. 5 is a flowchart for explaining an assistance control for a manipulation assistance.

It is further noted that a flowchart or the processing of the flowchart in the present application includes sections (also referred to as steps), which are represented, for instance, as S11. Further, each section can be divided into several sub-sections while several sections can be combined into a single section. Furthermore, each of thus configured sections can be referred to as a device, means, module, or processor and achieved not only as a software section in combination with a hardware device but also as a hardware section. Furthermore, the software section may be included in a software program, which may be contained in a non-transitory computer-readable storage media as a program product.

The following explains an example in which a manipulator being an occupant of the subject vehicle executes an input of manipulation information so as to change the set-up of the audio portion 3 to the screen of the display portion 4 in the vehicular navigation apparatus while the map image is displayed by the navigation portion 2.

First, as indicated in FIG. 2, the map image which is a base image is shown on the screen of the display portion 4 by the navigation portion 2 (D1). Then, by the manipulation information inputted by the manipulator, the image displayed on the screen of the display portion 4 changes from the map image into an audio setup image which is a manipulation image (D2). At this switchover, the manipulator intends to change the sound setting of the audio portion 3, and inputs the manipulation information, which is an instruction to change the display or screen from the map image to the audio setup image, to the content input manipulation button 11A.

Furthermore, based on the manipulation information inputted by the manipulator, the image displayed in the screen of the display portion 4 transits or switches from the audio setup image of the manipulation image to an equalizer setup image of the manipulation image (D3). Further, it switches from the equalizer setup image to a DSP (Digital Sound Processor) selection image (D4).

Then, a situation or event arises which interrupts the input manipulation for changing the setup of the audio portion 3. As indicated in FIG. 2 and FIG. 3, the manipulator thereby inputs an interruption instruction (i.e., interruption manipulation information) to interrupt the input to the image switchover instruction button 11B (S11). The input of the interruption instruction of interrupting the input manipulation is executed by carrying out a one-time depression (single click) to the image switchover instruction button 11B, for example.

The one-time depression or single-clicking of the image switchover instruction button 11B generates a signal that is to be inputted into the controller 12. The controller 12 outputs a control signal, which writes an image transition signal, to the image recording portion 14. The image transition signal includes image signals of an image transition from the displayed map image serving as the closest displayed base image up to the presently displayed DSP selection image serving as the last displayed image or interrupted displayed image that is displayed just before the image switchover due to the interruption. The image generation portion 13 outputs the image transition signal including the image signals of images from the closest displayed base image up to the last displayed manipulation image to the image recording portion 14 based on the control signal, to cause the image recording portion 14 to record the image transition signal (S12).

Furthermore, the controller 12 outputs a control signal which displays a map image of a base image on the screen of the display portion 4 to the image generation portion 13. Based on the received control signal, the image generation portion 13 acquires information about a present map image from the navigation portion 2, and outputs an image signal which displays this present map image to the display portion 4. Herein, the present map image may be also referred as an updated map image or a live map data. The display portion 4 displays the map image based on the inputted image signal (S13).

It is noted that this image transition signal written in the image recording portion 14 includes the image signals from the closest displayed base image to the last displayed manipulation image. In other words, this image transition signal contains image signals concerning the map image, the audio setup image, the equalizer setup image, and the DSP selection image, which have been displayed in the display portion 4.

Thereby, the screen of the display portion 4 displays as a base image the present map image newly outputted from the navigation portion 2 (D5). Then, when the manipulator inputs the manipulation information for a desired manipulation to the displayed map image, the controller 12 outputs the manipulation information to the navigation portion 2. The navigation portion 2 executes the process corresponding to the inputted manipulation information, and outputs a process result to the image generation portion 13. The image generation portion 13 generates an image signal based on the inputted process result, and outputs it to the display portion 4. The display portion 4 displays a desired image corresponding to the inputted manipulation information (S14, D6).

For instance, the manipulator inputs, to the displayed map image, the manipulation information, which scrolls the map or enlarges or reduces the map; thereby, the display portion 4 displays the map image that is scrolled, or enlarged or reduced. It is noted that the above desired manipulation information signifies manipulation information relative to the base image. This desired manipulation information does not include another manipulation information which transits from the base image into a different image or window. When the map image of the base image switches over to the different image or window, the image transition information held till then in the image recording portion 14 is reset or erased.

Then, the situation or event to interrupt the input manipulation disappears; thereby, the manipulator may intend to continue the input manipulation which was once interrupted. In such a case, as indicated in FIG. 4, the manipulator thereby inputs, to the image switchover instruction button 11B, a return instruction (i.e., return manipulation information) to return to the input of the manipulation information that was interrupted (S21). The input of the return instruction of the input manipulation is executed by carrying out two-time depression (short-interval double click) with a short time interval to the image switchover instruction button 11B, for example.

The two-time depression or double-clicking of the image switchover instruction button 11B generates a signal that is to be inputted into the controller 12. The controller 12 confirms whether the image signal (i.e., the image transition signal) written in the image recording portion 14 exists (S22). When the written image transition signal exists (S22: YES), the controller 12 outputs the control signal which reads the image transition signal. The image generation portion 13 reads the image transition signal written in the image recording portion 14 based on the control signal. The image generation portion 13 outputs the image trasnsition signal which displays the DSP selection image serving as the last displayed manipulation image to the display portion 4 based on the read image transition signal. The display portion 4 displays the DSP selection image as the last displayed manipulation image (S23, D7). In contrast, when the image transition signal written in the image recording portion 14 does not exist (S22: NO), the control to return to the input manipulation is not executed, but the presently displayed base image is continuously displayed.

It is noted that even if the DSP selection image serving as the last displayed manipulation image is displayed in the display portion 4, the manipulator is sometimes unable to remember what kind of manipulation information was already inputted. In that case, in order to remember the manipulation information which were inputted before the interruption, the manipulator inputs an assistance instruction (i.e., assistance manipulation information) to execute a recording assistance to the image switchover instruction button 11B (S31), as indicated in FIG. 5. The input of the assistance instruction is executed by carrying out a long depression for several seconds (long-period depression) to the image switchover instruction button 11B, for example.

The long-period depression of the image switchover instruction button 11B generates a signal that is to be inputted into the controller 12. The controller 12 outputs a signal which sets an image pointer to the closest displayed base image out of the image signals included in the image transition signal written in the image recording portion 14, and the image pointer is set to the closest displayed base image written in the image recording portion 14 (S32). Then, by executing the single click to the image switchover instruction button 11B, the controller 12 receives an image transition instruction to execute or manipulate an image transition (S33). The controller 12 receiving the image transition instruction outputs a control signal to display the image signal set by the image pointer, in the display portion 4. It is noted that by the first single-click, the image signal of the closest displayed base image is displayed in the display portion 4. The image generation portion 13 reads the image signal, which the image pointer is set to, from the image recording portion 14 based on the control signal, and outputs the read image signal to the display portion 4. The display portion 4 displays an image based on the inputted image signal (S34, D8).

Then, the controller 12 determines whether the image signal to which the image pointer is set is the last displayed manipulation image (S35). When the image signal set by the image pointer is the last displayed manipulation image (S35: YES), the display flow of the image transition in the recording assistance is ended, whereas the input of the manipulation information is continuously resumed (D9).

When the image signal set by the image pointer is not the last displayed manipulation image (S35: NO), the controller 12 outputs a signal to the image recording portion 14, the signal which changes the image pointer from the image signal, which has been set, to a manipulation image that is to be displayed subsequently (i.e., incrementing the image pointer) (S36). Then, the processing returns to S33 and the control is continued. Under the above configuration of the present embodiment, the manipulator is enabled to see the image transition from the closest displayed base image up to the last displayed manipulatiion image; thereby, the manipulator is reminded of the contents inputted up to the interruption of the input of the manipulation information, thereby enabling smooth resumption of the input of the manipulation information.

As explained above, even if the manipulator interrupts the input of the manipulation information, the manipulator can easily continue or resume the input of the manipulation information smoothly. In other words, because of smoothly returning to the input, the manipulator can easily determine an interruption of the input of the manipulation information, and concentrate on driving of the subject vehicle.

Furthermore, the image transition displayed or performed after inputting the recording assistance instruction is provided to switch over to a subsequent image only by executing a single-click of the image switchover instruction button 11B. The images can be thus switched or displayed according to the switchover speed that is desirable for the manipulator. In other words, the manipulator can relive the input manipulation of the manipulation information up to that time at the desired speed.

The button for the input of the recording assistance instruction is equal to the button into which the interruption instruction to interrupt the manipulation of inputting the manipulation information and the return button into which a return instruction is inputted. The input of the recording assistance instruction can be made by executing the long-period depression of the image switchover instruction button 11B; thus, as compared with the case where another button is pushed, the burden placed on the manipulator is mitigable.

The above embodiment explains an example case that the manipulation information input apparatus 1 is built in the vehicular navigation apparatus mounted in the subject vehicle. Without need to be limited thereto, the manipulation information input apparatus 1 and the vehicular navigation apparatus may be provided to be separate independent apparatuses, which communicate information or control signals with each other.

### Second Embodiment

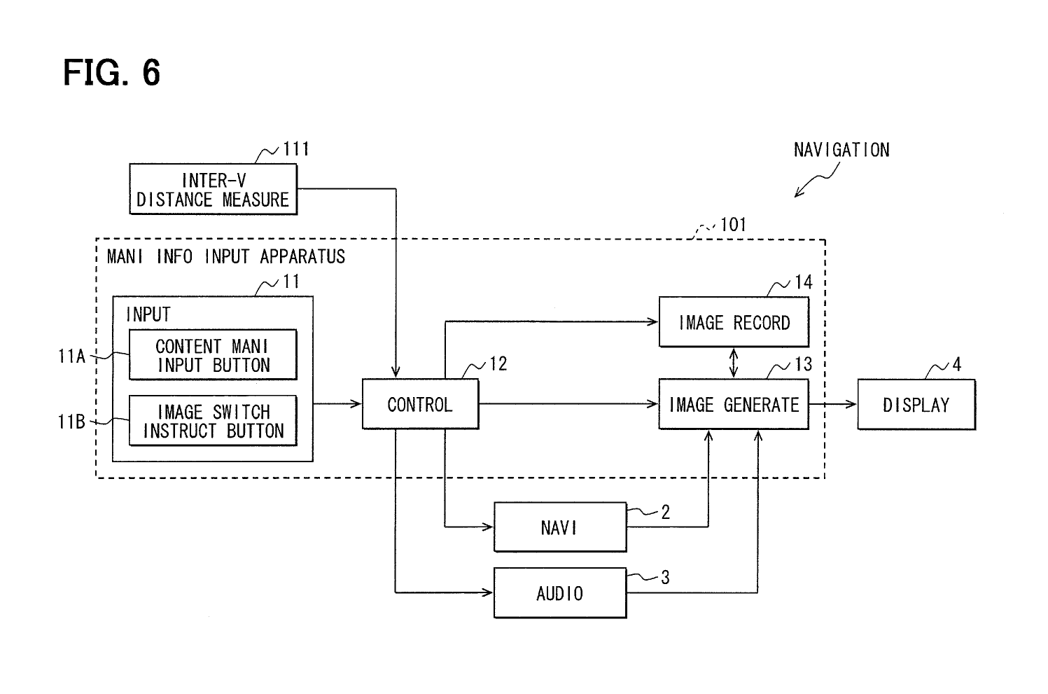

A second embodiment according to the present invention is explained with reference to FIG. 6. The manipulation information input apparatus according to the second embodiment has a basic configuration identical to that of the first embodiment. The second embodiment is different from the first embodiment in respect of a kind of a signal inputted into the manipulation information input apparatus. Therefore, in the present embodiment, only the manipulation information input apparatus is explained using FIG. 6 while omitting the explanation of other configuration. FIG. 6 is a block diagram illustrating a configuration of the manipulation information input apparatus and the vehicular navigation apparatus according to the second embodiment.

In the manipulation information input apparatus 101 of the present embodiment, as compared with the manipulation information input apparatus 1 of the first embodiment, a controller 112 also receives a signal from a source other than the input portion 11, and controls an image switchover from a manipulation image to a basic image based on the received signal. As indicated in FIG. 6, the signal (i.e., measurement signal) is inputted into the controller 112 of the manipulation information input apparatus 101 also from the inter-vehicle distance measurement portion 111.

The inter-vehicle distance measurement portion 111 measures a distance to a vehicle ahead of the subject vehicle (also referred to as a traveling-ahead vehicle). The inter-vehicle distance measurement portion 111 inputs a signal of the information concerning the measured distance with the traveling-ahead vehicle, which travels ahead of the subject vehicle, to the controller 112.

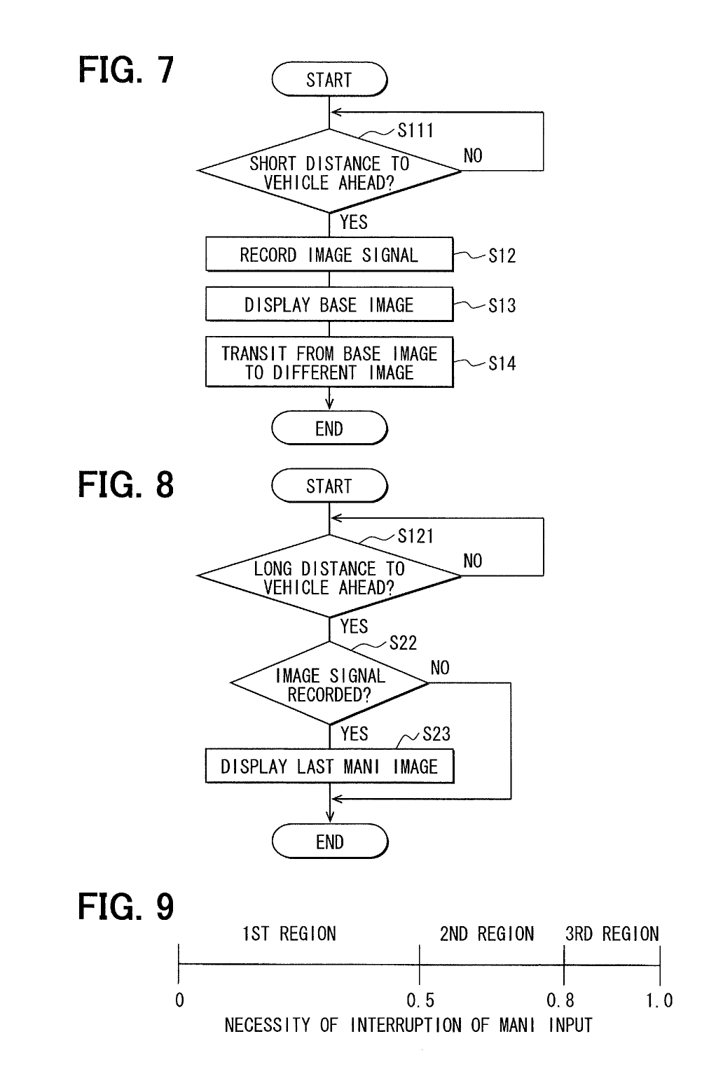

The following will explain an operation in the vehicular navigation apparatus and the manipulation information input apparatus 101. FIG. 7 is a flowchart diagram for explaining a control process which interrupts a input manipulation in the manipulation information input apparatus 101 of FIG. 6. FIG. 8 is a flowchart for explaining a return control which returns to the input manipulation.

The basic operation in the manipulation information input apparatus 101 of the present embodiment is the same as that of the manipulation information input apparatus 1 of the first embodiment. The second embodiment differs from the first embodiment in that the manipulation information input apparatus 101 operates also based on the information concerning the inter-vehicle distance to the traveling-ahead vehicle inputted from the inter-vehicle distance measurement portion 111. The following mainly explains such a different point while focusing on this point, with reference to FIG. 2, FIG. 7, and FIG. 8.

It is premised that when the display portion 4 is displaying the DSP selection image on the screen according to the manipulator's manipulation, an inter-vehicle distance between the subject vehicle and the traveling-ahead vehicle becomes short. In this case, the controller 112 determines whether the inter-vehicle distance to the traveling-ahead vehicle becomes short or narrow (i.e., a predetermined shorter-limited distance) based on the change in the information concerning the inter-vehicle distance to the traveling-ahead vehicle inputted from the inter-vehicle distance measurement portion 111 (S111). When it is detected that the inter-vehicle distance to the traveling-ahead vehicle becomes short (S111: YES), the controller 112 determines that an event or situation occurs which interrupts an input manipulation to change a setup of the audio portion 3. This determination at S111 is executed by comparing a predetermined distance with the inter-vehicle distance to the traveling-ahead vehicle, for example.

Then, the controller 112 outputs a control signal to write an image transition signal to the image recording portion 14 automatically, i.e., without waiting for an input of the interruption instruction to interrupt the input of the manipulation information by the manipulator. This image transition signal indicates an image transition from the closest displayed base image of the map data up to the DSP selection image of the last displayed manipulation image. The image generation portion 13 outputs the image transition signal including the image signals of images from the closest displayed base image up to the last displayed manipulation image to the image recording portion 14 based on the control signal, to cause the image recording portion 14 to record the signal (S12).

Furthermore, the controller 112 outputs a control signal which displays a map image of a base image on the screen of the display portion 4 to the image generation portion 13. Based on the received control signal, the image generation portion 13 acquires the information about the present map image from the navigation portion 2, and outputs an image signal which displays this present map image to the display portion 4. The display portion 4 displays the map image based on the inputted image signal (S13).

Then, as indicated in FIG. 8, the controller 112 determines whether the inter-vehicle distance to the traveling-ahead vehicle becomes long or great (i.e., a predetermined longer-limited distance) based on the change in the information concerning the inter-vehicle distance to the traveling-ahead vehicle inputted from the inter-vehicle distance measurement portion 111 (S121). When determining that the inter-vehicle distance to the traveling-ahead becomes long, the controller 112 determines that an event or situation occurs which returns to the manipulation to execute the setup of the audio portion 3.

Then the controller 112 determines whether the image transition signal is written in the image recording portion 14 (S22) automatically, i.e., without waiting for an input of a return instruction to return to the input of the manipulation information by the manipulator. When the written image signal exists (S22: YES), the controller 112 outputs the control signal which reads the image transition signal. The image generation portion 13 reads the image transition signal written in the image recording portion 14 based on the control signal. The image generation portion 13 outputs the image signal which displays the DSP selection image serving as the last displayed manipulation image to the display portion 4 based on the read image transition signal. The display portion 4 displays the DSP selection image as the last displayed manipulation image (S23, D7).

According to the above configuration, even if the interruption instruction which interrupts the input manipulation is not made by the manipulator, the image displayed on the screen of the display portion 4 is automatically switched from the manipulation image to the base image at the occurrence time of the event to interrupt the input manipulation. Thereby, even if the manipulator is during executing the input manipulation of the manipulation information, the manipulator can know the occurrence of the situation or event which needs to interrupt the input manipulation.

Further, even if the return instruction which returns to the input manipulation is not made by the manipulator, the image displayed on the screen of the display portion 4 is automatically switched from the base image to the last displayed manipulation image at the time when the event to interrupt the input manipulation is cancelled. Even if the manipulator oneself does not make an input of a return instruction, the display or operation can return to the input manipulation, thereby easing the burden to the manipulator.

In the above-mentioned embodiment, the signal relative to the inter-vehicle distance to the traveling-ahead vehicle is inputted to the controller 112 from the inter-vehicle distance measurement portion 111. Without need to be limited thereto, such a signal may be inputted from a LIDAR (Light Detection And Ranging), a laser radar, or a radar using a millimeter wave.

Furthermore, the signal inputted into the controller 112 may be a signal concerning the inter-vehicle distance to the traveling-ahead vehicle, a signal concerning a travel speed of the vehicle, or a signal concerning a result from a determination by an image recognition apparatus as to whether the vehicle is deviated from a travel lane. Without need to be limited to the above, another may be adopted.

When the signal concerning the travel speed of the vehicle is inputted, the following may be executed. When the vehicle runs (when the travel speed is a value other than zero), the controller 112 outputs a control signal which writes the image signal in the image recording portion 14 (S12) while outputting the control signal which displays the base image on the screen of the display portion 4 (S13). When the vehicle stops (when the travel speed becomes zero), the controller 112 outputs the control signal which reads the image signal from the image recording portion 14 while displaying the manipulation image in the display portion 4 (S23).

When the determination result by the image recognition apparatus is inputted, the following may be executed. When the vehicle is determined to have deviated from the travel lane, the controller 112 outputs a control signal which writes the image signal in the image recording portion 14 (S12) while outputting the control signal which displays the base image on the screen of the display portion 4 (S13). When the vehicle is determined to have returned to the travel lane, the controller 112 outputs a control signal to read the information concerning the image from the image recording portion 14 while displaying the manipulation image on the display portion 4 (S23).

As explained above, the controller 112 executes automatically an image switchover from a manipulation image to a base image at the time of the interruption of the manipulation, or from a base image to a manipulation image at the time of the return to the input manipulation. In such an image switchover, notification may be made by audio or display in an instrument panel, or not made by any means. Without need to be limited to the above embodiment, another may be adopted.

Further, when the controller 112 executes automatically an image switchover from a manipulation image to a base image at the time of the interruption of the input manipulation, or from a base image to a manipulation image at the time of the return to the manipulation, there may be provided an ON-OFF switch to control the image switchover or may not be provided. Without need to be limited to the above, another may be adopted.

### Third Embodiment

A third embodiment according to the present invention is explained with reference to FIG. 9. The manipulation information input apparatus according to the third embodiment has a basic configuration identical to that of the second embodiment. The third embodiment differs from the second embodiment in respect of an operation when an event or situation occurs which interrupts an input manipulation. Therefore, in the present embodiment, an operation taking place when the event occurs which interrupts an input manipulation is explained using FIG. 9 while omitting the explanation of other configuration.

As compared with the second embodiment, the manipulation information input apparatus 101 of the present embodiment urges the manipulator oneself to interrupt the input manipulation in cases that when a situation which interrupts the input manipulation occurs, a necessity of interrupting the input manipulation is comparatively low; the manipulation information input apparatus automatically (forcibly) interrupts the input manipulation in cases that a necessity of interrupting the input manipulation is comparatively high. This is a different point from the second embodiment.

The following explains a characterized point in an operation of the manipulation information input apparatus 101 of the present embodiment with reference to FIG. 2, FIG. 6, and FIG. 9. The explanation is omitted about the operation identical to that of the second embodiment. FIG. 9 is a diagram explaining a classification of a necessity degree in an input manipulation interruption.

When the DSP selection image is displayed on the screen of the display portion 4 according to the manipulator's manipulation, an inter-vehicle distance to a traveling-ahead vehicle becomes short. In such a case, the controller 112 determines whether the inter-vehicle distance to the traveling-ahead vehicle becomes short or narrow based on the change in the information concerning the inter-vehicle distance to the traveling-ahead vehicle inputted from the inter-vehicle distance measurement portion 111 (S111). When it is detected that the inter-vehicle distance to the traveling-ahead vehicle becomes short (S111: YES), the controller 112 determines that an event or situation occurs which interrupts an input manipulation to change a setup of the audio portion 3.

This determination at S111 is executed by comparing a first predetermined distance and a second predetermined distance with the inter-vehicle distance to the traveling-ahead vehicle, respectively, for example. According to the present embodiment, as illustrated in FIG. 9, the necessity degree of zero (0) is defined as being a state where there is no need to interrupt an input manipulation; the necessity degree of one (1.0) is defined as being a state where there is need to interrupt an input manipulation. The first predetermined distance corresponds to the necessity degree of 0.5; the second predetermined distance corresponds to the necessity degree of 0.8.

Further, as illustrated in FIG. 9, the necessity degrees are classified as follows. That is, the first region is defined as a region from the necessity degree of zero to the necessity degree of 0.5; the second region is defined as a region from the necessity degree of 0.5 to the necessity degree of 0.8; the third region is defined as a region from the necessity degree of 0.8 to the necessity degree of 1.0, for instance. In the first region, there is no need to interrupt an input manipulation. In the second region, since there is a need to interrupt an input manipulation but an urgency is low, the manipulator is only urged to interrupt the input manipulation. In the third region, since the urgency is high, the input manipulation is interrupted automatically. That is, the third embodiment differs from the second embodiment in that the second region is provided.

When the controller 112 determines that the necessity of interrupting the input manipulation is included in the second region, the controller 112 outputs a control signal for displaying an image to urge the manipulator to interrupt the input manipulation to the image generation portion 13.

The image generation portion 13 receiving the control signal changes a color tone of the manipulation image displayed in the display portion 4 depending on the necessity degree of interrupting the input manipulation, i.e., depending on the inter-vehicle distance to the traveling-ahead vehicle. For instance, the color tone of the displayed manipulation image is changed into a reddish color tone to follow an increase of the necessity degree from a lower point (0.5) having the low necessity degree of interrupting to a higher point (0.8).

The change in such a color tone of the manipulation image enables the manipulator to know that the necessity degree to interrupt the input manipulation becomes high. In other words, the manipulator is urged to interrupt the input manipulation. With reference to FIG. 3, when the manipulator inputs an interruption instruction to interrupt the input manipulation into the image switchover instruction button 11B (S11), the controller 112 outputs a control signal, which writes an image transition signal, to the image recording portion 14. The image transition signal includes image signals of an image transition from the map image serving as the closest displayed base image up to the presently displayed DSP selection image serving as the last displayed image that is displayed just before the image switchover due to the interruption. The image generation portion 13 outputs the image transition signal including the image signals of images from the closest displayed base image up to the last displayed manipulation image to the image recording portion 14 based on the control signal, to cause the image recording portion 14 to record the image transition signal (S12).

Furthermore, the controller 112 outputs a control signal which displays a map image of a base image on the screen of the display portion 4 to the image generation portion 13. Based on the received control signal, the image generation portion 13 acquires the information about the present map image from the navigation portion 2, and outputs an image signal which displays this present map image to the display portion 4. The display portion 4 displays the present map image based on the inputted image signal (S13).

When the necessity degree of interrupting the input manipulation is included in the first region, the manipulation image is displayed in the display portion 4 as it is, without changing the color tone. When the necessity degree is included in the third region, the image displayed in the display portion 4 is automatically changed from a manipulation image to a base image, thereby interrupting the input manipulation compulsorily.

Such a configuration enables the manipulator to be urged to execute an image switchover from the manipulation image to the base image when the necessity of the image switchover arises. Therefore, as compared with the case where the manipulator is not urged to execute the image switchover, the manipulator is prevented from overlooking the occurrence of the necessity state of the image switchover. In addition, as compared with the case where the image switchover is made automatically without urging it, there is no occurrence of the image swichover that is not intended, thereby preventing the manipulator from sensing stress.

In the above embodiment, the image switchover is urged by changing the color tone of the manipulation image. There is no need to be limited thereto. That is, (1) A base image such as a map image may be superimposed over the manipulation image such that the manipulation image appears transparently. As the necessity degree of interrupting increases, the transparency of the base image may be decreased. In other words, instead of the manipulation image, the base image may become visible. (2) The manipulation image may swing right and left on the screen. As the necessity degree of interruption increases, the magnitude of the swing may be increased, or the velocity of the swing may be increased. (3) The color tone of the manipulation image sways. As the necessity degree of interruption increases, the velocity of the sway may be increased or the image may blink.

### Fourth Embodiment

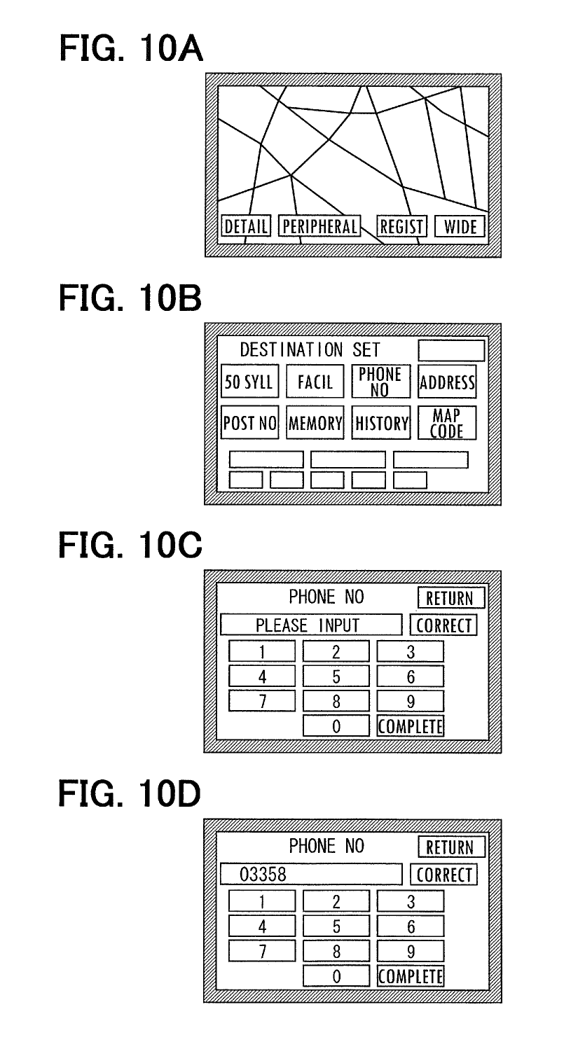

A fourth embodiment according to the present invention is explained with reference to FIGS. 10A to 13E. The manipulation information input apparatus according to the fourth embodiment has a basic configuration identical to that of the second embodiment. The fourth embodiment differs from the second embodiment in respect of the procedure or operation of returning to the interrupted input of the manipulation information. Therefore, in the present embodiment, the procedure of returning to the manipulation input is explained using FIG. 10A to 13E while omitting the explanation of other configuration.

As compared with the second embodiment, the manipulation information input apparatus 101 of the present embodiment is different in that the manipulator can resume the input of the manipulation information during or in the middle of displaying the recorded image transition in the recording assistance. Further, in the second embodiment, after the last displayed manipulation image, which was displayed just before the interruption of the input of the manipulation information, is displayed again in the display portion 4, the manipulator resumes the input of the manipulation information. In contrast, in the fourth embodiment, before the last displayed manipulation image is displayed, the input of the manipulation information can be resumed.

The following explains a characterized portion in an operation of the manipulation information input apparatus 101 of the present embodiment with reference to FIG. 6, FIG. 10A to 13E. The explanation is omitted about the operation identical to that of the second embodiment. FIGS. 10A to 10D are diagrams explaining a displaying flow when a manipulator executes an image switchover from a map image of a base image up to a window or image where a destination input using a telephone number is still in a middle of the processing. FIG. 10A illustrates a map image serving as a base image. FIG. 10B illustrates a destination designation image. FIG. 10C illustrates a telephone number input image. FIG. 10D illustrates a middle state where a telephone number is inputted only up to a middle of the number.

First, the following explains the case where the manipulator inputs a destination into the navigation portion 2 using a telephone number. As indicated in FIG. 10A, the map image (i.e., a live or present map data) which is a base image is shown on the screen of the display portion 4 by the navigation portion 2. Then, the manipulator inputs a destination into the navigation portion 2 using a telephone number. The manipulator depresses a destination setup button first, thereby causing the display portion 4 to display a destination setup image (also referred to as a destination designation image or window) serving as a manipulation image, as indicated in FIG. 10B. Then, a telephone number input image serving as a manipulation image is displayed, as indicated in FIG. 10C, by carrying out the depression of the telephone number button. Then, the manipulator starts the input of the telephone number of the destination by carrying out the depression of the number buttons.

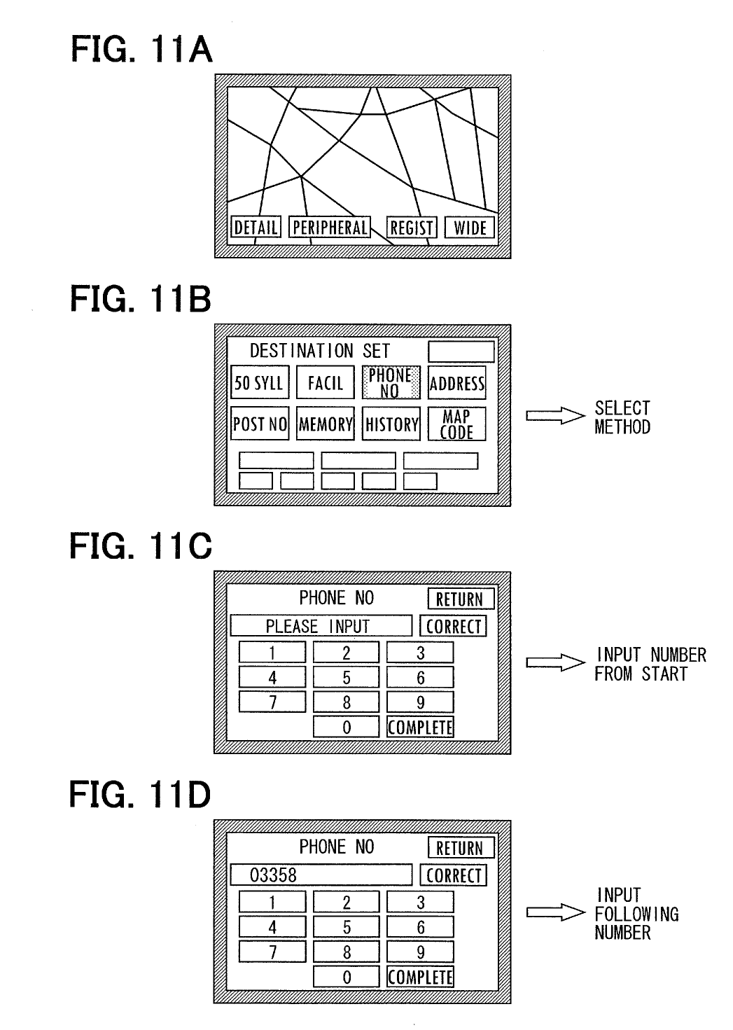

FIGS. 11A to 11D are diagrams explaining a displaying flow of an image transition by a recording assistance according to the fourth embodiment. FIG. 11A illustrates a map image serving as a base image. FIG. 11B illustrates a destination setup image. FIG. 11C illustrates a telephone number input image. FIG. 11D illustrates a middle state where a telephone number is inputted only up to a middle of the number.

When the vehicle, which has been stopped, re-starts at a middle of the input of the telephone number, the input of the manipulation information is interrupted by the controller 112. Thereafter, when the vehicle stops, the return to the input of the manipulation information can be possible. Herein, when the manipulator executes a long-period depression of the image switchover instruction button 11B, an image transition (i.e., a display of the recording assistance) is executed so as to display from the displayed map image up to the displayed image where the telephone number of the destination is inputted up to the middle of the telephone number, as indicated in FIGS. 11A to 11D.

First, as indicated in FIG. 11A, the map image serving as the base image is displayed. Then, as indicated in FIG. 11B, the destination setup image serving as a manipulation image is displayed. Here, the telephone number button is highlighted as a button that was selected in the displayed destination setup image. Here, the manipulator can stop the display of the recording assistance and newly select a method of the destination setup.

Then, as indicated in FIG. 11C, the telephone number input image is displayed. Here, the manipulator can stop the display of the recording assistance and input a telephone number of the destination from the start. Furthermore, as indicated in FIG. 11D, the telephone number input image is displayed in the state where the work of the input manipulation was interrupted. The manipulator can re-start the input of the telephone number from the following number, i.e., from the middle of the telephone number that was inputted or displayed before the interruption.

Furthermore, the manipulator can change the order of the images that are displayed in the recording assistance as needed. For instance, the image transition may be provided to be from FIG. 11A towards FIG. 11D in this normal order, from FIG. 11D towards FIG. 11A in the reverse order, or jumping from the middle to FIG. 11A or FIG. 11D.

For example, suppose the case when the image switchover instruction button 11B is a crisscross shaped key. The rightward depression provides a single image switchover (i.e., to the next image) in the normal order. The leftward depression provides a single image switchover (i.e., back to the just previously displayed image) in the reverse order. The upward depression provides a jump to the last displayed manipulation image. The downward depression provides a jump to the closest displayed base image.

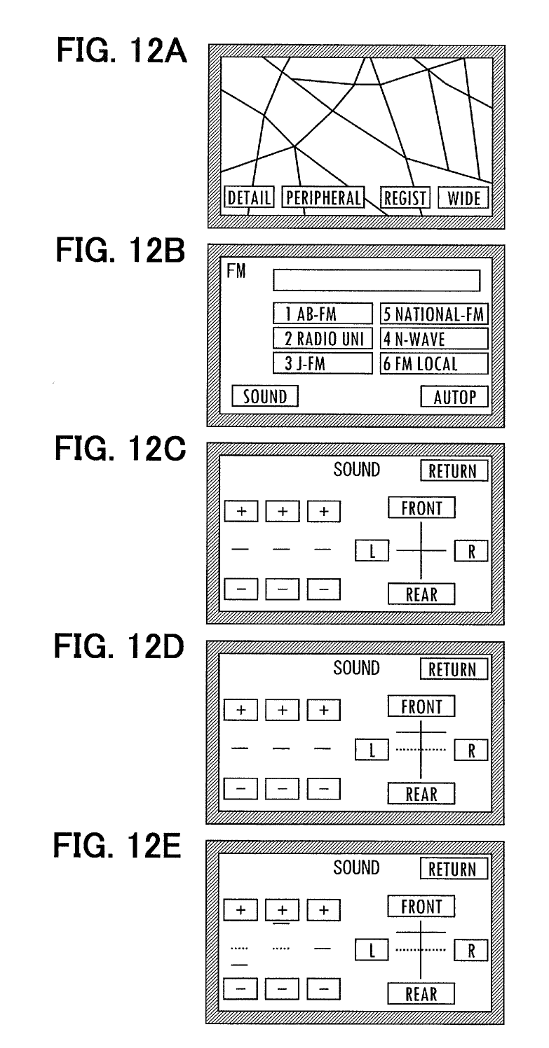

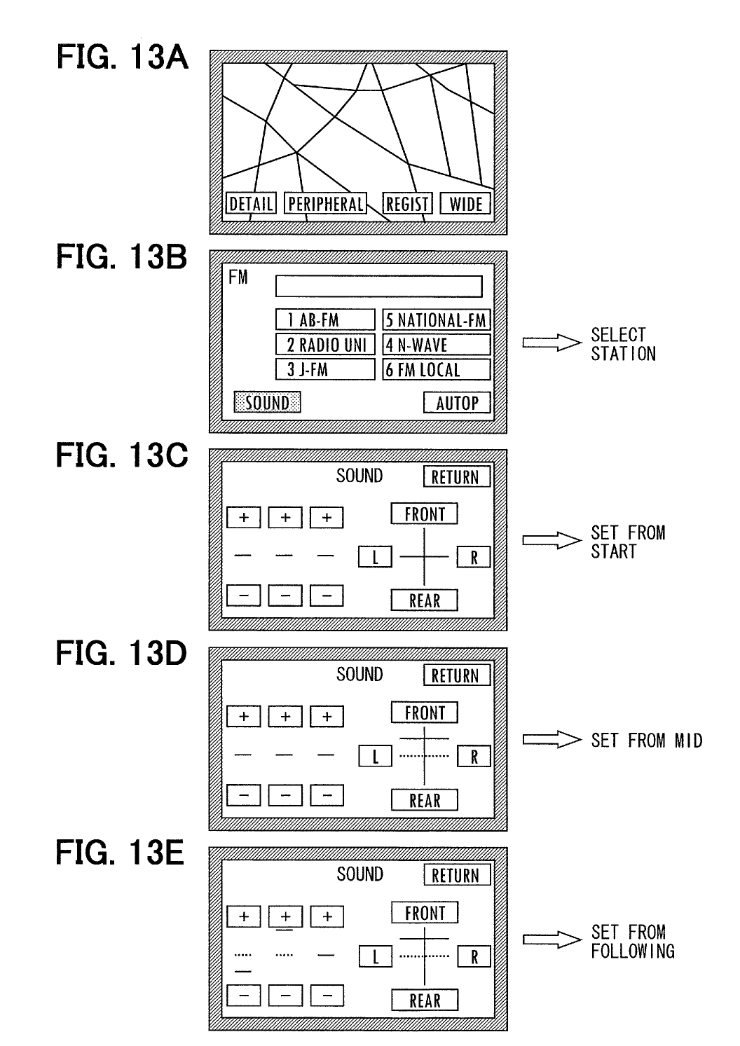

Next, the following explains the case where the manipulator designates or sets up the sound of the audio portion 3 with reference to FIGS. 12A to 12E and FIGS. 13A to 13E. FIGS. 12A to 12E are diagrams explaining the case where the manipulator executes a sound setup of the audio portion 3 while starting from a map image serving as a base image. FIG. 12A illustrates a map image (i.e., a present or live map image) serving as a base image. FIG. 12B illustrates a radio station selection image. FIG. 12C illustrates a sound setup image. FIGS. 12D and 12E illustrate images which indicate the state of setting the sound.

As indicated in FIG. 12A, the present or live map image which is a base image is shown on the screen of the display portion 4 by the navigation portion 2. Then, the manipulator inputs sound setup into the audio portion 3. The manipulator displays on the screen of the display portion 4 first the radio station channel selection image which is a manipulation image as indicated in FIG. 12B by carrying out the depression of the radio button. Then, the sound setup image serving as a manipulation image is displayed, as indicated in FIG. 12C, by carrying out the depression of a sound button.

In the sound setup image, as indicated in FIG. 12D, the manipulator manipulates a position button (i.e., a crisscross shaped button in a right portion of FIG. 12D), setting the balance of Front, Rear, Left, and Right of the sound. As illustrated in FIG. 12E, the manipulator manipulates the sound quality button (i.e., three paired buttons in a left portion of FIG. 12E), setting the balance of the magnitude of the sounds such as a high-pitched sound and a low-pitched sound.

Suppose the case where the manipulator requests an interruption of the manipulation input by applying a single-click to the image switchover instruction button 11B when the manipulation input is finished up to the setup of the balance using the sound quality button. The above sound setup may be possible regardless of the vehicle stopping or running. The controller 112 does not interrupt automatically the input of the manipulation information.

FIGS. 13A to 13E are diagrams explaining a displaying flow of a recorded image transition by a recording assistance according to the fourth embodiment. FIG. 13A illustrates the map image serving as a base image. FIG. 13B illustrates the radio station selection image. FIG. 13C illustrates the sound setup image. FIGS. 13D and 13E illustrate the images which indicate the state of setting the sound.

Thereafter, the manipulator makes a double-click to the image switchover instruction button 11B and a long-period depression to the same button. The image transition (i.e., a display of the recording assistance) is executed so as to display from the displayed map image up to the displayed sound setup image, as indicated in FIGS. 13A to 13E.

First, as indicated in FIG. 13A, the previously displayed map image serving as the base image is displayed. Then, as indicated in FIG. 13B, the previously displayed radio station selection image serving as a manipulation image is displayed. Here, the SOUND button is highlighted as a button that was selected in the previously displayed radio station selection image. Herein, the manipulator may stop the display of the recording assistance and, then, select the radio station.

Then, as indicated in FIG. 13C, the previously displayed sound setup image is displayed. Here, the manipulator can stop the display of the recording assistance and input of the sound setup from the start. Furthermore, as indicated in FIG. 11D, the previously displayed image, which sets the balance of Front, Rear, Right, and Left of the sound by manipulating the position button, is displayed. Here, the manipulator can stop the display of the recording assistance and input the sound setup from the middle of the processing. As indicated in FIG. 11E, the previously displayed image, which sets the balance of the sound quality by manipulating the sound quality button, is displayed subsequently. The manipulator can re-start the input of the balance of the sound quality ongoingly.

Under such a configuration, at the time when the manipulator is reminded of the work that was interrupted before the interruption of the input manipulation, the input of the manipulation information can be resumed promptly. In other words, the input of the manipulation information can be resumed without presenting all the display of the recording assistance. The manipulator does not need to wait for the completion of all the display of the recording assistance.

### Fifth Embodiment

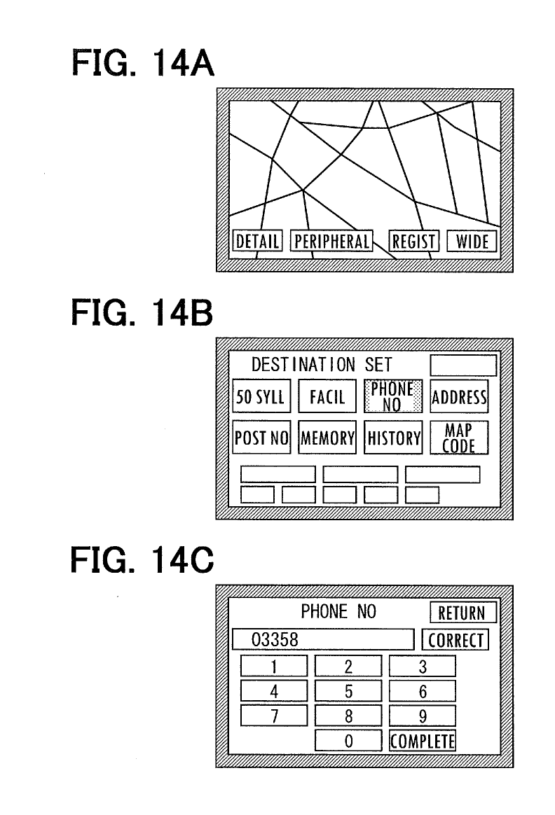

A fifth embodiment according to the present invention is explained with reference to FIGS. 14A to 17C. The manipulation information input apparatus according to the fifth embodiment has a basic configuration identical to that of the second embodiment. The fifth embodiment differs from the second embodiment in respect of a process or operation of returning to the interrupted input of the manipulation information. Therefore, in the present embodiment, the operation of returning to the input manipulation is explained using FIG. 14A to 17C while omitting the explanation of other configuration.

As compared with the second embodiment, the manipulation information input apparatus 101 of the present embodiment is different in that when the image transition in the recording assistance is presented, not all the images included in the image transition, but a part of the images is displayed.

The following explains a characterized portion in an operation of the manipulation information input apparatus 101 of the present embodiment with reference to FIG. 6, FIGS. 10A to 10D, FIGS. 12A to 12E, and FIG. 14A to FIG. 17C. The explanation is omitted about the operation identical to that of the second embodiment.

First, the following explains the case where after interrupting the input of the destination using the telephone number, the image transition is presented in the recording assistance. The method for the manipulator to input a destination using a telephone number to the navigation portion 2, and the previously displayed images are identical to those of the fourth embodiment (FIGS. 10A to 10D). The explanation of them is omitted.

FIGS. 14A to 14C are diagrams explaining a displaying flow of an image transition by a recording assistance according to the fifth embodiment. FIG. 14A illustrates the map image serving as a base image. FIG. 14B illustrates the destination setup image. FIG. 14C illustrates the telephone number input image in a middle state where a telephone number is inputted only up to a middle of the number.

The input was interrupted in the state where the input of the telephone number is executed up to the middle of the telephone number. Thereafter, the return to the the input of the manipulation information is enabled. In this case, as the manipulator applies the long-period depression to the image switchover instruction button 11B, an image transition (i.e., a display of the recording assistance) is started so as to display from the previously displayed map image up to the previously displayed image where the telephone number of the destination is inputted up to the middle, as indicated in FIGS. 14A to 14C. First, as indicated in FIG. 14A, the map image serving as the base image is displayed. Then, as indicated in FIG. 14B, the destination setup image serving as a manipulation image is displayed. Here, the telephone number button is highlighted as a button that was selected in the previously displayed destination setup image.

Furthermore, as indicated in FIG. 14C, the telephone number input image is displayed in the state where the work of the input manipulation was interrupted. That is, the image transition of the present recording assistance omits the display of the initial image at the time of starting the telephone number input (i.e., the telephone number input image before the telephone number is inputted). In contrast, the image transition of the present recording assistance displays the image in the state where the telephone number is inputted up to the middle of the telephone number. The manipulator can re-start the input of the telephone number from the following number while recognizing the displayed image.

Next, the following explains the case where before the interruption of the input, the manipulator completes setup of the sound of the audio portion 3, and thereafter the image transition is presented in the recording assistance. The method for the manipulator to set the sound of the audio portion 3 and the displayed images are identical to those of the fourth embodiment (see FIGS. 12A to 12E; thus, the explanation of them is omitted.

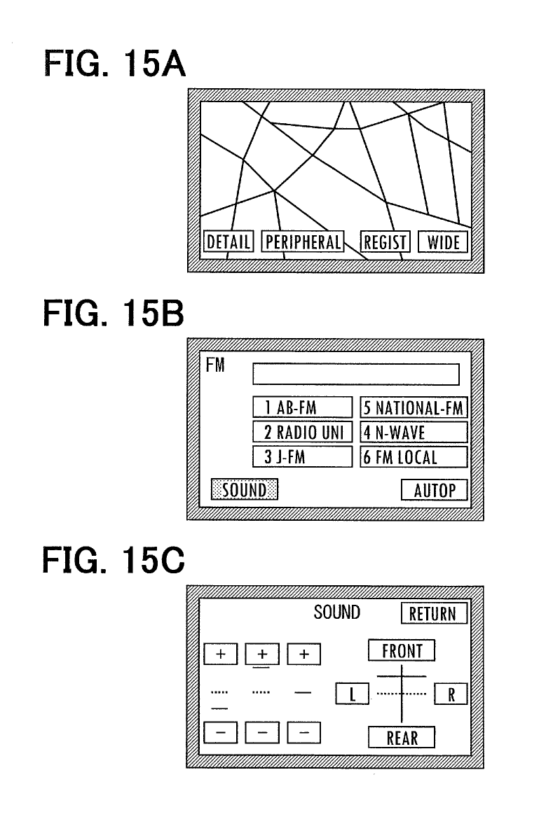

FIGS. 15A to 15C are diagrams explaining a displaying flow of a recorded image transition by a recording assistance according to the fifth embodiment. FIG. 15A illustrates the map image serving as a base image. FIG. 15B illustrates the radio station selection image. FIG. 15C illustrates the image which indicates the state where the sound setup was completed to the final point.

The input was interrupted in the state where the sound setup of the audio portion 3 is completed to the final point. Thereafter, the return to the the input of the manipulation information is enabled. In this case, as the manipulator applies the long-period depression to the image switchover instruction button 11B, the image transition (i.e., a display of the recording assistance) is started so as to display from the previously displayed map image up to the previously displayed sound setup image, as indicated in FIGS. 15A to 15C.

First, as indicated in FIG. 15A, the map image serving as the base image is displayed. Then, as indicated in FIG. 15B, the radio station selection image serving as a manipulation image is displayed. Here, the SOUND button is highlighted as a button that was selected in the previously displayed radio station selection image.

Further, as indicated in FIG. 15C, the sound setup image is displayed which indicates the state where both the input manipulation by the position button and the input manipulation by the sound quality button have been completed. That is, the display is omitted with respect to (i) the initial image of the sound setup (i.e., the image where any input manipulation by the position button and any input manipulation by the sound quality button are not started or executed) and (ii) the image where only the input manipulation by the position button is completed. In contrast, the display is still made with respect to the image in the state where the input manipulation by the position button and the input manipulation by the sound quality button are completed. The manipulator can re-start continuously the input of the sound setup while recognizing the displayed image.

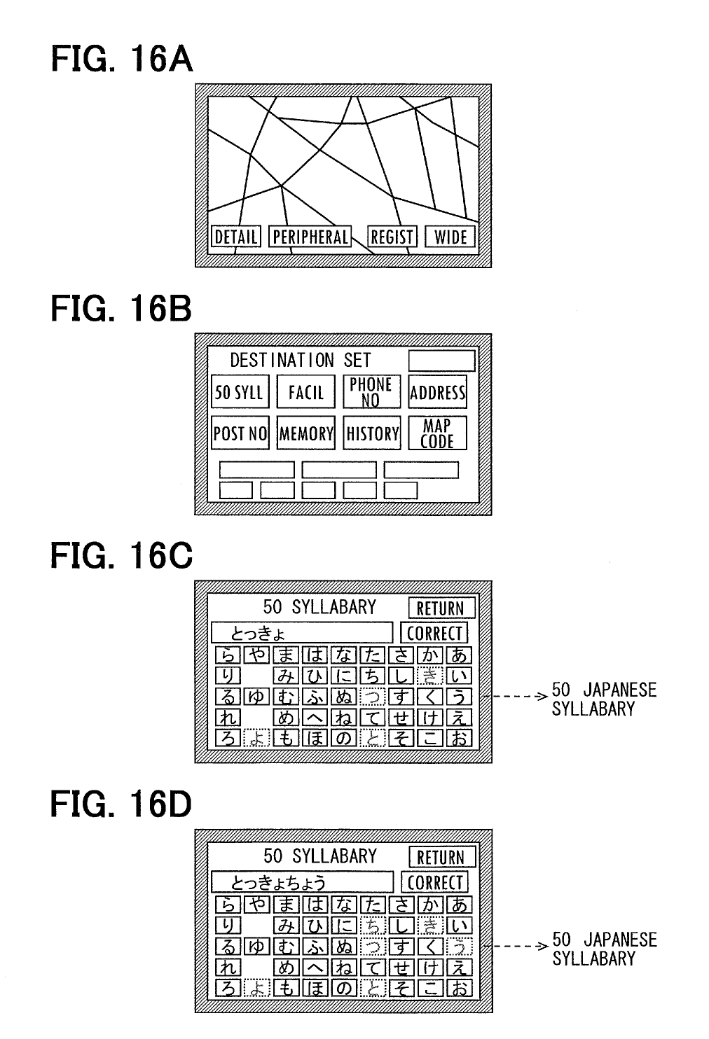

Next, the following explains the case where before the interruption of the input the manipulator completes the input of the destination using a 50 Japanese syllabary up to the final point, and thereafter the image transition is presented in the recording assistance. FIGS. 16A to 16D are diagrams explaining a displaying flow from a present map image of a base image up to an image or window where a destination input using the 50 Japanese syllabary is completed to the final point. FIG. 16A illustrates a present map image serving as a base image. FIG. 16B illustrates a destination setup image. FIG. 16C illustrates a 50 Japanese syllabary input image in a middle state where the name of a destination is inputted only up to a middle point of the name of the destination. FIG. 16D illustrates the 50 Japanese syllabary input image in the state where the name of the destination is inputted completely up to the final point.

First, the following explains the case where the manipulator inputs a destination into the navigation portion 2 using a 50 Japanese syllabary. As indicated in FIG. 16A, a present live map image which is a base image is shown in the screen of the display portion 4 by the navigation portion 2. Then, the manipulator inputs the destination into the navigation portion 2 using the 50 Japanese syllabary. The manipulator displays on the screen of the display portion 4 first a destination setup image serving as a manipulation image, as indicated in FIG. 16B by carrying out the depression of the destination setup button. The 50 Japanese syllabary button is depressed to thereby display a 50 Japanese syllabary image illustrated in FIG. 16C. Then, Japanese hiragana character buttons are depressed to input the destination name. FIG. 16C illustrates a state where the destination name is inputted up to a middle point. Then, the manipulator continues the input of the destination name up to the final point. FIG. 16D indicates the image in the state where the destination name is inputted completely up to the final point.

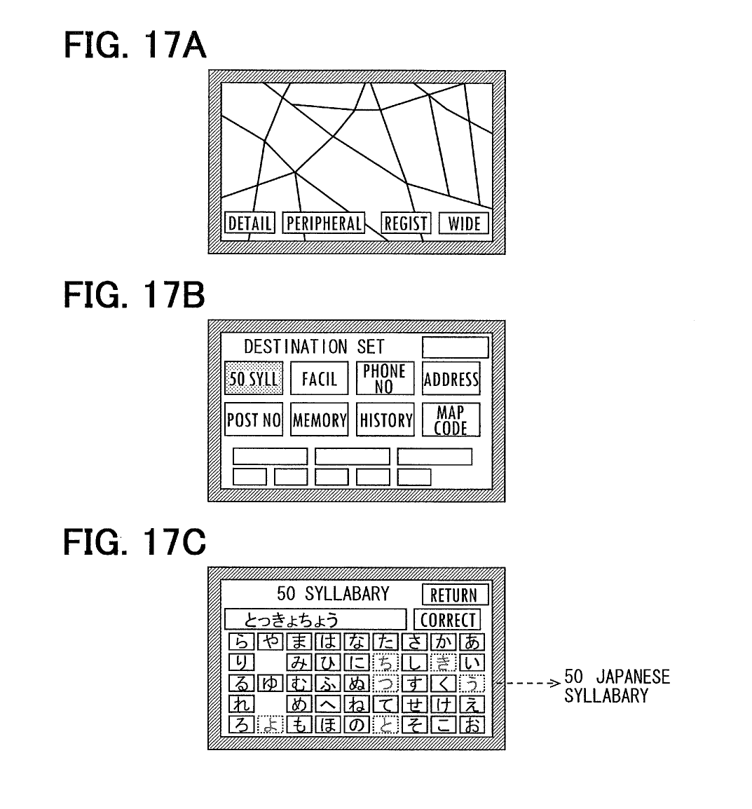

FIGS. 17A to 17C are diagrams explaining a displaying flow of an image transition by a recording assistance according to the fifth embodiment. FIG. 17A illustrates the map image serving as a base image. FIG. 17B illustrates the 50 Japanese syllabary input image in a middle state where the name of the destination is inputted only up to a middle point of the name of the destination. FIG. 17C illustrates the 50 Japanese syllabary input image in the state where the name of the destination is completely inputted up to the final point.

As mentioned above, the input is interrupted after the input of the destination name is completed to the final point. Thereafter, the manipulator applies a double-click to the image switchover instruction button 11B and applies a long-period depression to the button. Thereby, the image transition (i.e., a display of the recording assistance) is executed so as to display from the previously displayed map image up to the previously displayed 50 Japanese syllabary input image, as indicated in FIGS. 17A to 17C.

First, as indicated in FIG. 17A, the previously displayed map image serving as the base image is displayed. Then, as indicated in FIG. 17B, the previously displayed destination setup image serving as the manipulation image is displayed. Then, as indicated in FIG. 17C, the previously displayed image in the state where the destination name is inputted completely up to the final point is displayed. That is, the display of the 50 Japanese syllabary input image where the destination name was inputted to the middle point is omitted; the image in the state where the destination name is completely inputted up to the final point is displayed. The manipulator can also re-start or amend the input of the 50 Japanese syllabary while recognizing the displayed image.

Thus, the displayed manipulation images in the image transition of recording assistance are limited to a part of all the images from the map image of the closest displayed base image up to the 50 Japanese syllabary input image of the last displayed manipulation image. As compared with the method to display all the manipulation images included in the image transition, a time necessary for the display in the recording assistance can be shorted.

### Sixth Embodiment

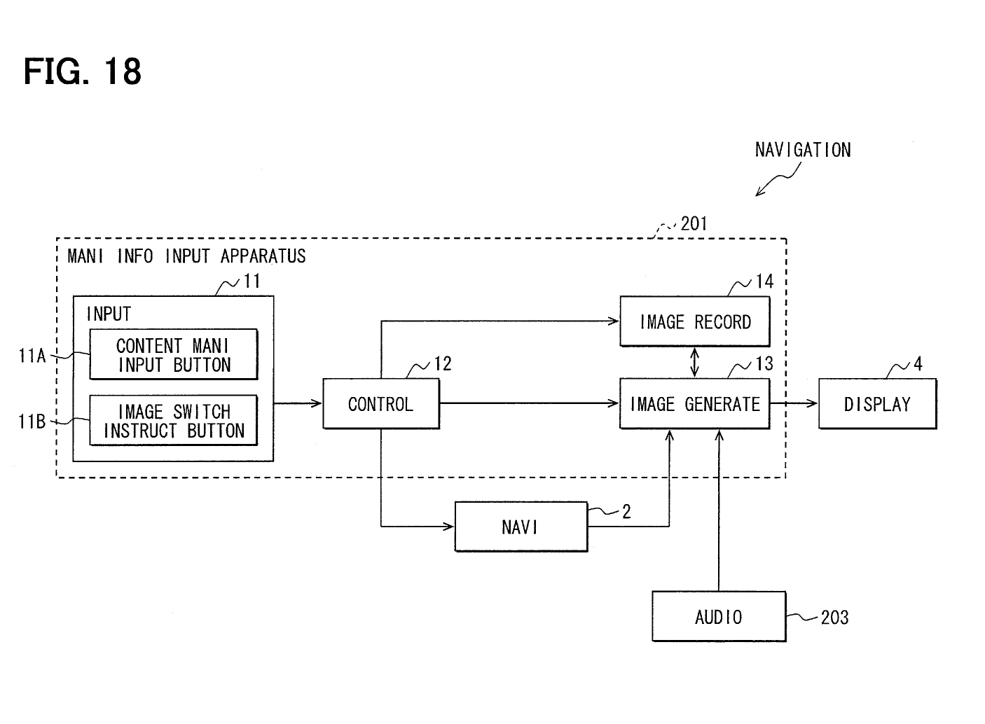

A sixth embodiment according to the present invention is explained with reference to FIG. 18. FIG. 18 is a block diagram illustrating a configuration of the manipulation information input apparatus 201 and the vehicular navigation apparatus according to the sixth embodiment.

As indicated in FIG. 18, the basic configuration of the manipulation information input apparatus 201 of the vehicular navigation apparatus of the present embodiment is different from the first embodiment in that a control signal of the manipulation information input apparatus is not inputted into an audio portion 203 that serves as a manipulated instrument. In other words, the sixth embodiment differs from the first embodiment in that the audio portion 203 is not controlled by the manipulation information input apparatus 201.

The audio portion 203 receives directly manipulation information by the manipulator without the manipulation information input apparatus 201 intervening. For example, the audio portion 203 may be a portable music player device, which is connected to the vehicular navigation apparatus so as to display an image of the portable music player device in the display portion 4.

Next, the following explains a characterized point of the present embodiment that is a display method of an image transition in the recording assistance. The manipulator inputs manipulation information directly to the audio portion 203, and the input result of the manipulation information is displayed in the display portion 4. The input result of the manipulation information displayed in the display portion 4 applies to a screen copy; screen-copied manipulation information is written in the image recording portion 14 after the selection.

The selection method of the screen copy is explained as follows. Two screen copies which adjoin in a time base are contrasted, and the degree X of the change between the two screen copies is obtained by computation using the following expression (1). The degree X of the change obtained by the computation is contrasted with predetermined threshold value. When the degree X of the change is greater than the predetermined threshold value, one of the screen copies that is earlier than the other is written in the image recording portion 14. In contrast, when the degree X of the change is equal to or less than the predetermined threshold value, the one of the screen copies that is earlier than the other is not written in the image recording portion 14.

$$[ Expression 1 ]$$

$$X = \sqrt{{\sum }_{PixelNumberInImage} {( \begin{matrix}( PixelValue ( i ; Image\_at \_time ( t - 1 ) ) ) - \\ ( PixelValue ( i ; Image\_at \_Time ( t ) ) )\end{matrix} )}^{2}}$$

Then, when a situation or event which interrupts an input of manipulation information occurs during the input, the manipulator interrupts the input manipulation by executing a single-click of the image switchover instruction button 11B. The controller 12 displays a present live map image serving as a base image in the display portion 4 when the interruption instruction of the manipulation is inputted. Thereafter, in cases that the situation of interruption is cancelled and the manipulator resumes the input manipulation that was interrupted, the manipulator applies a double-click to the image switchover instruction button 11B, thereby inputting a return instruction to return to the input manipulation that was once interrupted. Furthermore, when executing the recording assistance, the manipulator applies a long-period depression to the image switchover instruction button 11B, thereby inputting a display instruction of the recording assistance.

When the display instruction of the recording assistance is inputted, while reading the data of the screen copies written in the image recording portion 14, the controller 12 outputs a control signal to cause the display portion 4 to display the read data to the image generation portion 13. The images of the screen copies written in the image recording portion 14 are displayed in the display portion 4 individually as an image transition of the recording assistance. Since the image displayed in the display portion 4 is an image of the screen copy, the manipulator cannot make an input manipulation to the image (image of the screen copy) displayed as the recording assistance.

When the image transition of the recording assistance reaches an image of the last screen copy (a previously displayed image just before the interruption of the manipulation input), the image recording portion 14 outputs a control signal which switches from the image displayed on the display portion 4 to an image which can receive an input of the manipulation information.

Thus, even if a manipulation image is relative to the audio portion 203 into which the control signal is not inputted from the manipulation information input apparatus 201, the display of the recording assistance can be made, thereby easing a burden to the manipulator.

### Seventh Embodiment

A seventh embodiment according to the present invention is explained with reference to FIGS. 10A to 10D, and FIGS. 14A to 14C. The manipulation information input apparatus 101 according to the seventh embodiment has a basic configuration identical to that of the second embodiment. It differs in that the information concerning the image stored by the image recording portion 14 is a control signal concerning manipulation information.

Next, the following explains a characteristic point of an operation of the manipulation information input apparatus 101 according to the present embodiment. First, the following explains the case where the manipulator inputs a destination into the navigation portion 2 using a telephone number.

Similarly to the fourth embodiment, first, the present map image as a base image is displayed on the screen of the display portion 4 by the navigation portion 2 (see FIG. 10A). Then, the manipulator inputs the destination into the navigation portion 2 using the telephone number. The manipulator causes the display portion 4 to display a destination setup image serving as a manipulation image by carrying out the depression of the destination setup button (see FIG. 10B). By depressing a telephone number button, a telephone input image serving as a manipulation image is displayed (refer to FIG. 10C). Then, the manipulator starts the input of the telephone number of the destination by carrying out the depression of the number buttons.

At this time, the following control signals outputted by the controller 112 are written in the image recording portion 14: a control signal outputted according to the depression of the destination setup button; a control signal outputted according to the depression of the telephone number button; and a control signal outputted by the depression of the number buttons.

Then, the input of the manipulation information is interrupted in a middle point of the telephone number. Thereafter, the return to the the input of the manipulation information is enabled. In this case, the manipulator applies a long-period depression to the image switchover instruction button 11B, thereby starting the display of the image transition in the recording assistance.

In this case, the controller 112 determines whether the control signal outputted according to the depression of the destination setup button, the control signal outputted according to the depression of the telephone number button, and the control signal outputted according to the depression of the telephone number button are written in the image recording portion 14. When determining that those control signals are written, the controller 112 outputs a control signal which reads those control signals. Furthermore, the controller 112 outputs a control signal which generates an image signal which displays a manipulation image in the display portion 4 based on the control signal read from the image generation portion 13. The display portion 4 displays the manipulation image which is the display of the recording assistance based on the image signal outputted from the image generation portion 13.

Under the above configuration, the image recording portion 14 only needs to store information that is necessary for generating an image newly such as a control signal outputted according to the depression of the destination setup button; a control signal outputted according to the depression of the telephone number button; and a control signal outputted according to the depression of the telephone number button. The above configuration can reduce a time required for the data writing and data reading for the image recording portion 14. Furthermore, the increase of the storage area needed for the image recording portion 14 can be suppressed.

While aspects of the disclosure described herein are already recited in the preceding summary, further optional aspects thereto may be set out as follows.

For instance, as an optional aspect of the disclosure, when the return instruction is inputted via the input portion after having switching to the present base image, the controller may output an image transition display control signal to the image generation portion so as to display in the display portion all displayed images included in the image transition from the closest displayed base image up to the interrupted displayed manipulation image, based on the information on image transition that is recorded in the image recording portion.

Further, as an optional aspect of the disclosure, when the return instruction is inputted via the input portion after having switching to the present base image, the controller may output an image transition display control signal to the image generation portion so as to display in the display portion a part of all displayed images included in the image transition from the closest displayed base image up to the interrupted displayed manipulation image, based on the information on image transition that is recorded in the image recording portion.

Further, as an optional aspect of the disclosure, the interruption instruction and the return instruction may include a measurement signal that is from a measurement portion that measures a state external to the apparatus; a correspondence between the measurement signal and the interruption image switchover and a correspondence between the measurement signal and the return image switchover may be previously stored; and the controller may output a control signal based on the previously stored correspondences.

Thus, even if the manipulator does not input an instruction of an image switchover via the input portion, the image displayed in the display portion is automatically switched, based on the measurement signal outputted from the measurement portion, from the interrupted displayed manipulation image to a present base image; further, the displayed image is switched from the present base image to the interrupted displayed manipulation image again.

Further, as an optional aspect of the disclosure, the interruption instruction and the return instruction may include (i) an instruction from a manipulator and (ii) a measurement signal that is from a measurement portion that measures a state external to the apparatus; a correspondence between the measurement signal and the interruption image switchover is previously stored; and when a measurement signal which corresponds to the interruption image switchover is inputted while the interrupted displayed image is being displayed, the controller may output to the image generation portion an urge control signal so as to display an urge image to urge the manipulator to accept the interruption image switchover.

Thus, when the situation where the displayed image needs to be switched from a displayed manipulation image to a present base image occurs, the manipulator can be urged to execute or accept an image switchover from the manipulation image to the present base image. Therefore, as compared with the case where the manipulator is not urged, the manipulator can be prevented from not noticing the occurrence of the state that is required to execute an image switchover. In addition, as compared with the case where the image switchover is made automatically without urging, the image switchover that the manipulator does not intend does not occur. This prevents the manipulator from sensing stress.

Further, as an optional aspect of the disclosure, based on the information on image transition recorded in the image recording portion, an image included in the displayed image transition may be newly generated and the generated image may be displayed in the display portion.

Such a configuration can provide an advantage as compared with the case where, for example, the image recording portion records captured image data, which is acquired by screen capturing a base image or manipulation image, or an image signal (information concerning live screen) which is the aggregation of signals which controls the brightness and color in the pixels included in the images, and the images are displayed using the recorded image signals. That is, as compared with such a conventional means to display images, the above configuration can reduce a time required for the data writing and data reading for the image recording portion or the image generation portion. Furthermore, the increase of the storage area needed for the image recording portion can be suppressed. That is, the information required to newly generate the images, such as the control signal inputted into the image generation portion from the controller, has data volume smaller than the above-mentioned image data and image signal. Therefore, the writing and read-out of the information with the image generation portion can be executed quickly, and the storage area needed can be reduced.

Further, as an optional aspect of the disclosure, a content of an image displayed as the base image may be registered previously and changeable.

Thus, the manipulator can determine as needed an image displayed as a base image. Furthermore, the information concerning the image written in the image recording portion is information concerning the image transition from the closest displayed base image up to the last displayed manipulation image. Therefore, by enabling the selection of the base image, the information concerning the images written in the image recording portion can be indirectly selected.

It will be obvious to those skilled in the art that various changes may be made in the above-described embodiments of the present invention. However, the scope of the present invention should be determined by the following claims.

What is claimed:

1. A manipulation information input apparatus to display manipulation information in a display portion, the apparatus comprising:
an image generation portion to cause the display portion to display manipulation images and base images, the manipulation image being directed at a manipulated instrument, the base image being an image other than the manipulation images;
an input portion to receive an interruption instruction and a return instruction, the interruption instruction executing an interruption image switchover to switch a displayed image from an interrupted displayed manipulation image to a present base image, the return instruction executing a return image switchover to return to the interrupted displayed manipulation image after having switched to the present base image;
an image recording portion to record information on image transition from a closest displayed base image up to the interrupted displayed manipulation image, while the interrupted displayed manipulation image is being displayed in the display portion; and
a controller,
wherein when the interruption instruction is inputted via the input portion, the controller is configured to output (i) a recording control signal to the image recording portion so as to record the information on image transition information, and (ii) a base image display control signal to the image generation portion so as to display the present base image in the display portion,
wherein when the return instruction is inputted via the input portion, the controller is configured to output an image transition display control signal to the image generation portion so as to display in the display portion the image transition from the closest displayed base image up to the interrupted displayed manipulation image, based on the information on image transition that is recorded in the image recording portion.

2. The manipulation information input apparatus according to claim 1,
wherein when the return instruction is inputted via the input portion after having switching to the present base image, the controller outputs an image transition display control signal to the image generation portion so as to display in the display portion all displayed images included in the image transition from the closest displayed base image up to the interrupted displayed manipulation image, based on the information on image transition that is recorded in the image recording portion.

3. The manipulation information input apparatus according to claim 1,
wherein when the return instruction is inputted via the input portion after having switching to the present base image, the controller outputs an image transition display control signal to the image generation portion so as to display in the display portion a part of all displayed images included in the image transition from the closest displayed base image up to the interrupted displayed manipulation image, based on the information on image transition that is recorded in the image recording portion.

4. The manipulation information input apparatus according to claim 1,
wherein the interruption instruction and the return instruction include a measurement signal that is from a measurement portion that measures a state external to the apparatus,
wherein a correspondence between the measurement signal and the interruption image switchover and a correspondence between the measurement signal and the return image switchover are previously stored,
wherein the controller outputs a control signal based on the previously stored correspondences.

5. The manipulation information input apparatus according to claim 1,
wherein the interruption instruction and the return instruction include (i) an instruction from a manipulator and (ii) a measurement signal that is from a measurement portion that measures a state external to the apparatus,
wherein a correspondence between the measurement signal and the interruption image switchover is previously stored,
wherein when a measurement signal which corresponds to the interruption image switchover is inputted while the interrupted displayed image is being displayed, the controller outputs to the image generation portion an urge control signal so as to display an urge image to urge the manipulator to accept the interruption image switchover.

6. The manipulation information input apparatus according to claim 1, wherein based on the information on image transition recorded in the image recording portion, an image included in the displayed image transition is newly generated and the generated image is displayed in the display portion.

7. The manipulation information input apparatus according to claim 1,
wherein a content of an image displayed as the base image is registered previously and changeable.
